(19) United States
(12) Patent Application Publication
(10) Pub. No.: US 2009/0226594 A1
(43) Pub. Date: Sep. 10, 2009

(54) Method for Obtaining Monocotyledon Plant Grains for Human or Animal food

(76) Inventors: Joël Abecassis, Le Cres (FR); Alexandre Bouniol, Bagnols Les Bains (FR); Marc Chaurand, Montferrier (FR)

Correspondence Address: Blakely Sokoloff Taylor And Zafman, 1279 Oakmead Parkway, Sunnyvale, CA, 94085-4040, US

(21) Appl. No.: 11/921,434

(22) PCT Filed: Jun. 3, 2005
(86) PCT No.: PCT/EP2005/052574

§ 371 Date: Nov. 29, 2007

(51) Int. Cl. A23L 1/10; A23B 9/02; A23B 9/08

(52) U.S. Cl. 426/627; 426/484; 426/466; 426/472; 426/462

(57) ABSTRACT

The present invention relates to a method for obtaining grains of monocotyledonous plants, notably of poaceae and in particular of graminae, remarkable in that it comprises at least the following steps for harvesting plants in an immature condition, then separating the grains, and then removing the glumes and/or glumellae of the grains without drying or torrefaction in order to obtain immature, raw and entire grains substantially without glumes and/or glumellae. Another object of the invention relates to immature grains of monocotyledonous plants, notably of poaceae and in particular of graminae, the glumes and/or glumellae of which have been removed, capable of being obtained by a method according to the invention. The invention also relates to a food composition comprising grains according to the invention. Finally, a last object of the invention relates to a method for removing the husk(s) surrounding a vegetable material to be treated, remarkable in that it consists at least in the following steps of introducing the products into a fluid, then of projecting the fluid on at least one plate, the impact of the products mixed with the fluid causing removal of the husk(s) surrounding the vegetable material; as well as a device for applying this method.

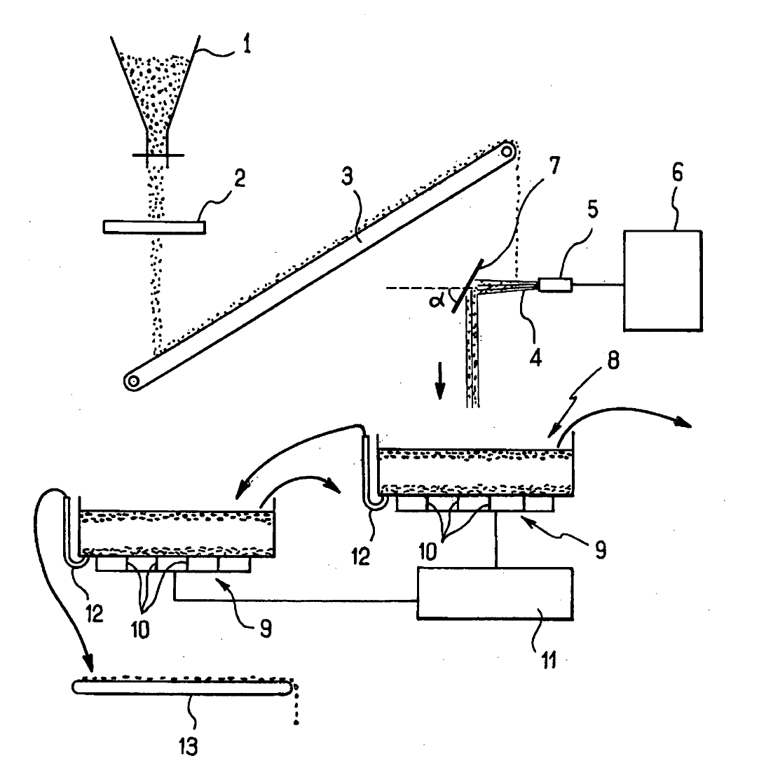

The present invention relates to a method for making a product intended for feeding humans or animals, from monocotyledonous plants, notably poaceae and in particular graminae, and to a product obtained according to said method.

In the field of foodstuffs based on graminae, in addition to rice and pasta obtained from hard wheat, grains of ordinary uncooked wheat, of puffed wheat coated with caramelized sugar, or even pil-pil or bulgur which consist in crushed hard wheat grains, are well-known.

In order to allow a larger variety of starchy products capable of accompanying meat or fish dishes or of entering the composition of desserts or first courses such as salads or the like, methods have already been devised for making precooked and husked hard wheat grains capable of being cooked in boiling water for about 10 minutes.

This is for example the case of European Patent EP 0561092 which describes a method for continuously making a product intended for feeding humans. The method consists of selecting as raw material, hard wheat grains which, after cleaning and calibration, are subject to a hydration treatment in order to allow gelatinization of the starch contained in the grains and then the grains are cooked so as to accelerate migration of water right up to the core of the grain. The grains are then dried, cooled and then mechanically husked before undergoing a treatment causing their expansion which increases the porosity of the wheat grains and which makes said grains non-sticky. The wheat grains obtained according to this method have a moisture level from 12-13%, the moisture level of the grains increasing during their cooking in boiling water, and a maximum oligoelement content of 33.5 for calcium, 37.8 for magnesium and 3.08 for iron, the aforementioned values being expressed in mg per 100 g. Moreover, the wheat grains after being cooked have a slight taste of hazelnut and bran.

This foodstuff, although having oligoelement contents larger than those of other starchy foods such as pasta and rice as well as particular organoleptic characteristics, has the drawback of requiring a cooking time of at least 10 minutes which is longer than that for pasta and rice. Further, during their making method, these wheat grains lose their germs and their husks which contain important nutrients.

One of the objects of the invention is therefore to find a remedy to these drawbacks and to propose a novel product intended for feeding humans having better oligoelement and fiber contents, better bioavailability of minerals and ease of preparation because of its water content.

For this purpose and according to the invention, a method is proposed for obtaining grains of monocotyledonous plants, notably of poaceae and in particular graminae, remarkable in that it comprises at least the following steps for harvesting graminae in an immature condition, then for separating the grains, and then for removing glumes and/or glumellae of the grains without drying or roasting in order to obtain raw and entire immature grains, substantially without any glumes and/or glumellae.

The monocotyledonous plants are preferably selected from poaceae, and more preferentially from graminae such as rice, wheat, barley, oats, rye, millet, sorghum, etc. . . . Moreover, by “substantially without any glumes and/or glumellae” is meant a glume level of less than 15 per 1,000.

The graminae preferably consist in hard wheat grains which, taking their immature condition into account, have a green color.

It is well understood that the foodstuff according to the invention is ready to be consumed either cold in the same way as maize for example, or hot after cooking for a few seconds in a microwave oven or for 2-3 minutes over a slow heat.

Advantageously, the grains are harvested when their moisture level is between 70% and 50%. In particular, the thereby harvested wheat grains upon completion of the method have a green color with a green index (100-a) between 92 and 120, and luminance (L) between 50 and 65.

Another object of the invention relates to immature grains of monocotyledonous plants, notably of poaceae and in particular graminae, for which the glumes and/or glumellae have been removed, capable of being obtained by a method according to the invention.

These immature grains have a total fiber content between 12 and 20% and they have a green index (100-a) between 95 and 120, and a luminance (L) between 50 and 65.

Moreover, the grains have a phytic acid content between 2 and 3.2 g/g and ferulic acid content between 1,800 and 2,600 μg/g. Further, the potassium/phosphorous ratio is larger than 1.

The invention also relates to a food composition comprising grains according to the invention. This food composition may consist in any so-called ready-to-eat dish in which the grains according to the invention form an ingredient or in any transformation of the grains with or without any additive, as a juice, mash, soup, dough, sauce, compote, etc. . . .

Another object of the invention relates to a method for removing one or several husks surrounding a vegetable material to be treated comprising at least the following steps for introducing the vegetable material to be treated into at least one fluid, and then for projecting the fluid mixed with said vegetable material to be treated onto a plate, the impact causing removal of the husk(s) surrounding the vegetable material.

Finally, a last object of the invention relates to a device for removing one or several husks surrounding a vegetable material comprising at least means for forming at least one fluid flow, means for introducing the products into the fluid flow and a plate onto which the fluid flow transporting the products is projected.

By vegetable material to be treated, is meant any vegetable material surrounded by a husk such as stems, fruit, grains, almonds. The treatment according to the invention allows removal of one or several external husks surrounding said vegetable material such as the skin of a fruit, of the glumes or glumellae of grains of monocotyledonous plants or even of the pericarp surrounding certain tissues, while substantially retaining the integrity of the remaining vegetable material after treatment. Advantageously, this vegetable material is selected from fruit, vegetables, grains, and more particularly grains of monocotyledonous plants. The method according to the invention is more particularly suitable for treating immature vegetable tissues.

Other advantages and characteristics of the methods and products according to the invention will become better apparent from the description of several alternative embodiments given as non-limiting examples, with reference to the single FIGURE schematically illustrating the device for removing husks surrounding a vegetable material to be treated according to the invention.

In this non-limiting example, a method will be described for making immature wheat grains ready to be consumed; however the making method according to the invention may be applied to all poaceae including graminae such as oats, barley, etc. . . . By poaceae are meant herbaceous plants forming lawns or with rhizomes, comprising a stem consisting of a sheath and a blade, and the inflorescence of which consisting of grouped spikelets develops inside the highest sheath.

The method for making immature wheat grains comprises a first step for harvesting the wheat in an immature condition, i.e. a condition in which the wheat grains are green and in which the albumen sugars have not yet been totally transformed into starch and generally have a milky or pasty aspect, and for separating the grains. The harvest of immature wheat grains is carried out by means of a farming machine comprising a specific cutting bar when the moisture level of the wheat grains is between 70% and 50%, and preferably when the moisture level is between 63% and 52%, so that the finished product has a green color with a green index (100-a) between 95 and 120 and a luminance (L) between 50 and 65 as this will be detailed later on. More specifically, the harvest of wheat grains is carried out before the raffinose content, expressed as a percentage of dry material, reaches 0.4%. As an indication, it will be observed that the raffinose content of mature wheat is of the order of 1.2%. Further, during maturation of the wheat grains, the sugar, fructose, glucose and maltose contents and the free fatty acid content decrease.

It is obvious that raffinose, fructose, glucose contents, etc. . . . additionally depend on the variety of the graminae, on the sum of the average daily temperatures since ear emergence of the graminae.

The specific cutting bar comprises a cylinder firmly attached to a frame mounted on an axle provided with radial teeth obtained in a resilient material such a rubber for example, and which is driven into rotation in the direction opposite to the advance of the machine. With the use of this specific cutting bar, it is thereby possible to harvest and to shell the immature wheat grains which are particularly fragile considering their high moisture content due to their immaturity.

The harvest of immature wheat grains may be carried out by means of a traditional combine harvester. In the case of using a combine harvester for harvesting, the cutting bar of the harvester should be adjusted to a predetermined height in order to obtain entire ears which are recovered by means of a belt, to undergo subsequent threshing in order to shell the immature wheat grains.

Considering the fragility of the immature wheat grains, the harvested wheat grains are preferably placed in an inert atmosphere in order to limit their oxidation capable of denaturing the organoleptic properties of the wheat grains. The wheat grains are then placed in a harvesting bin and mixed with dry ice blocks, and then covered with a tarpaulin. Dry ice sublimates into carbon dioxide which remains trapped under the tarpaulin thereby maintaining the wheat grains in an inert atmosphere.

These wheat grains are either frozen and then stored before their subsequent treatment or treated before their harvesting in order to remove their glumes and/or glumellae.

With reference to the single FIGURE, the device for removing the glumes and/or the glumellae consists of a hopper 1 in which the harvested immature wheat grains or the frozen immature wheat grains are placed, of a sorter/separator 2 placed under the hopper 1 and a conveyor belt 3 placed under the sorter/separator 2, the wheat grains falling on the conveyor belt 3 at their exit from the sorter/separator. At the end of the conveyor belt 3, the wheat grains fall under the effect of gravity into a water jet 4 obtained by means of a nozzle 5 fed by a pressurized water source 6. The pressurized water source 6 and the nozzle 5 deliver a water jet at a pressure between 50 and 200 bars. The wheat grains are mixed with the water jet 4 directed against a rigid plate 7 tilted relatively to the axis of the water jet 4 according to an angle α between 40 and 50°, and preferably equal to 45°. The angle α may advantageously be varied according to any value, depending on the pressure of the water jet notably, the plate 7 being mounted on a joint for example.

It is obvious that the device may comprise several water jets 4 directed towards one or more plates 7 without departing from the scope of the invention.

During the impact of the water jet 4 into which the wheat grains are mixed, the glumes and/or glumellae are detached from the wheat grains. The water, the wheat grains and the glumes and/or glumellae then fall into a settling tank 8 placed under the plate 7 and provided with stirring means 9. These stirring means 9 consist in water jets 10 mixed with air emerging in the bottom of the settling tank 8. These water and air jets 10 are supplied by a source 11. As the wheat grains are denser than the glumes and/or glumellae, they fall to the bottom of the settling tank 8 and are removed from the latter by a Venturi extraction system 12. The glumes and/or glumellae as for them remain at the surface of the settling tank and are removed from the settling tank by spillover for example. The wheat grains are possibly transported by any suitable means into a second settling tank 8′ also comprising stirring means 9′ and a Venturi system 12 for extracting wheat grains, identical with those of the first settling tank 8.

It is obvious that the wheat grains are successively immersed in several settling tanks 8, 8′ until all the glumes and/or glumellae are extracted substantially. By the term “extracted substantially”, is meant a level of glumes and/or glumellae present in the wheat grains of less than 15 per 1,000.

The wheat grains are then placed on a vibrating table 13 in order to drain the wheat grains before their subsequent treatment.

Thus, the method for removing glumes and/or glumellae at least consists in the following steps for introducing immature wheat grains into at least one fluid, and then for projecting the fluid on a plate, the impact of the wheat grains mixed with the fluid causing removal of the glumes and/or glumellae surrounding the wheat grains.

The products are preferably introduced into a water jet which has a pressure between 50 and 200 bars.

It is quite obvious that the wheat grains may be introduced into one or several flows of any fluid, such as air for example, without departing from the scope of the invention.

After impact on the plate of the wheat grains mixed with water, the mixture of water, of wheat grains and glumes and/or glumellae, is recovered in at least one settling bath in order to separate the glumes and/or glumellae from the wheat grains. The wheat grains are then removed from the bath and then drained, said draining being preferably achieved by stirring said wheat grains.

It will be observed that, according to the method according to the invention, the glumes and glumellae of the wheat grains are removed while limiting alteration of the pericarp and of the structure of the grain.

It is quite obvious that removal of the glumes and/or glumellae from the wheat grains may be achieved by any equivalent means, such as by a suitable mechanical beating and/or rubbing and/or dry and/or wet abrasive mechanical action without however departing from the scope of the invention.

Moreover, it will be observed that the method for removing glumes and/or glumellae from the immature wheat grains may be extended to removing the husk of any vegetable matter to be treated such as fruit and/or vegetables and/or the like.

The glumes and/or glumellae of the wheat grains having been removed, said raw immature wheat grains are then cooked by a hydrothermal cooking method in an atmosphere comprising steam at a temperature between 70 and 200° C. during one or several phases ranging from 10 to 120 minutes.

It is quite obvious that the wheat grains may undergo one or several thermal treatments by any suitable means such as microwaves without departing from the scope of the invention.

After these thermal treatment(s), the wheat grains are conditioned in metal tins and/or flexible polyolefinic packages or the like.

Accessorily, brine is mixed with the wheat grains before their conditioning.

The thereby obtained wheat grains are able to be consumed either cold in the same way as maize for example, or hot after cooking for a few seconds in a microwave oven or for 2-3 minutes over a slow heat, and they have the following characteristics:
Physical Characteristics after Draining:
Calibration: between 2-5 mm, and preferably between 2 and 4 mm.
Weight of 1,000 grains: between 10 and 75 g and preferably between 20 and 40 g.
Moisture: between 65 and 75% and preferably between 67 and 74%.
Protein content: 12%±3%.
Total (both soluble and insoluble) fiber content: between 12 and 20% and more particularly between 15 and 18% of dry material.

Color (Lab CIE 1976 standard):

| | |
|---|---|
| Luminance (L) | Between 50 and 65 |
| Green index (100-a) | Between 95 and 120 |

Color was measured here by using a spectrocolorimeter using an incident beam normal to the sample with diffuse reflection of the Minolta CR-310 type.

Biochemical characteristics
Amino acids (% m.s)

| | |
|---|---|
| Aspartic acid | 5.9 |
| Threonine | 3.1 |
| Serine | 4.0 |
| Glutamic acid | 26.1 |
| Proline | 9.7 |
| Glycine | 3.3 |
| Alanine | 4.5 |
| Valine | 4.9 |
| Isoleucine | 3.5 |
| Leucine | 6.8 |
| Tyrosine | 2.8 |
| Phenylalanine | 4.2 |
| Histidine | 4.4 |
| Lysine | 5.0 |
| Arginine | 5.9 |
| Cysteine | 2.0 |
| Methionine | 1.6 |
| Tryptophan | 1.1 |
| Total nitrogen content | 1.8 |
| (% m.s.) | |
| Reducing sugar contents | Between 1.5 and 4.5 |
| (% m.s.) | |
| Fructose (% m.s.) | Between 0.74 and 1.21 |
| Sucrose (% m.s.) | Between 0.82 and 0.82 |
| Glucose (% m.s.) | Between 0.57 and 0.71 |
| Raffinose (% m.s.) | Between 0 and 0.4 |
| Maltose (% m.s.) | Between 0.10 and 0.17 |
| Ribose (% m.s.) | Between 0.01 and 0.03 |
| Non-reducing sugars | Between 0.54 and 0.60 |
| (mg/grain) | |
| Pentosans (% m.s.) | Between 3.2 and 3.7 |
| Fructans (% m.s.) | 18.4 |
| Starch (% m.s.) | 60.0 |
| Starch distribution | 20-30 μm |
| Amylase (% m.s.) | Between 16.64 and 20.90 |
| Amylopectin (%) | Between 79.10 and 83.36 |
| Amylase/amylopectin ratio | Between 1/3.8 and 1/5 |
| α-amylasic activity (I.U./g) | 3.86 |
| Total lipids (% m.s.) | Between 2.87 and 3.34 |
| Sterols (mg/g) | Between 31 and 52 |
| Monoglycerides (mg/g) | Between 18 and 31 |
| 1,2-diglycerides (mg/g) | Between 112 and 115 |
| 1,3-diglycerides (mg/g) | Between 109 and 116 |
| Triglycerides (mg/g) | Between 201 and 558 |
| Phosphatidyl ethanolamine | Traces |
| (mg/g) | |
| Phosphatidyl serine (mg/g) | Traces |
| Lecithin (mg/g) | Between 0.38 and 0.50 |
| Monogalactosyl diglycerides | 0.94 |
| (mg/g) | |
| Magnesium (mg/100 g) | Between 106.6 (+/−16) and 115.6 (+/−10) |
| Calcium (mg/100 g) | Between 56.7 (+/−4) and 59.9 (+/−4) |
| Iron (mg/100 g) | Between 2.5 (+/−0.2) and 3.3 (+/−0.2) |
| Zinc (mg/100 g) | Between 4.0 (+/−0.4) and 4.1 (+/−0.3) |
| Copper (μg/100 g) | Between 587.1 (+/−40) and 599.5 (+/−50) |
| Potassium (mg/100 g) | Between 616 (+/−52) and 646 (+/−34) |
| Phosphorus (mg/100 g) | Between 376 (+/−116) and 400 (+/−30) |

It will be observed that the potassium/phosphorus ratio is larger than 1 indicating that it is well assimilated by the human organism.

| | | |
|---|---|---|
| Phytic acid content: | 2.8 | mg/g |
| Ferulic acid content: | 2,200 | μg/g |

Moreover it will be noted that the phytic acid content of the thereby obtained wheat grains is particularly low, thereby providing good bioavailability, whereas the ferulic acid content guarantees anti-oxidant potential.

Moreover, it will be observed that the product obtained according to the method has a smaller content in phytic acids or phytates than the content of said acids in mature wheat grains thereby improving bioavailability of minerals such as iron or zinc. The lysine content, which is an amino acid indispensable to humans, is larger than the lysine content of mature wheat grains and, considering a lower starch content and a larger fructan content than the content of mature wheat grains, the dietetic fiber content is larger than the content of mature wheat grains. This high fructan content indicates a source of fructo-oligosaccharides (FOS) which have prebiotic functions providing proliferation of bifid bacteria, and a reduction in novice bacteria, protection of hepatic functions, reduction in blood pressure, an anti-cancer effect, etc. . . . By “prebiotic” agents are understood components which are fermented by the own intestinal bacteria of the human body and which thereby have a positive effect on the composition of the intestinal flora.

It is quite obvious that the values reported above may vary from one harvest to another; the plots on which the wheat is grown and the encountered climatic conditions not being homogenous.

Further, it is actually obvious that these immature wheat grains may enter any type of food composition, such as so-called ready-to-eat dishes in which the grains according to the invention form an ingredient, or in any transformation of the grains, with or without any additive, as a juice, mash, soup, pasta, sauce, compote, etc. . . .

According to an alternative embodiment of the method in accordance with the invention, the raw immature wheat grains without any glumes are dried until they have a moisture level less than or equal to 15%. After this drying, the dried wheat grains may be reduced to the form of a semolina according to methods well-known to one skilled in the art in order to provide either flour or semolina able to enter the composition of food products such as pasta, couscous, etc. . . .

Alternatively, the dried wheat grains are roasted and/or torrefied and then possibly husked. These dried and husked immature wheat grains may then be cooked in boiling water, with a cooking time less than 15 minutes, in the same way as the food product described in European patent EP 0561092. These dried and husked immature wheat grains may also be crushed in order to obtain a product similar to “frekeh”, also called “firik”.

Finally, it is obvious that the method according to the invention may be adapted to all types of monocotyledonous plants, notably poaceae, such as oats, rye, etc. . . . and the examples which have been just given are only particular and by no means limiting illustrations as to the fields of application of the invention.

1. A method for obtaining grains of monocotyledonous plants, notably of poaceae, and in particular of graminae, characterized in that it comprises at least the following steps:
harvesting plants in an immature condition, and then
separating the grains, and then
removing glumes and/or glumellae from the grains without drying or torrefaction, in order to obtain raw and entire immature grains, substantially without glumes and/or glumellae.

2. The method according to the preceding claim, characterized in that the plants are harvested when the moisture level of the grains is between 70% and 50% so that the finished product has a green color with a green index (100-a) between 92 and 120, and a luminance (L) between 50 and 65.

3. The method according to claim 2, characterized in that harvesting the plants is carried out when the moisture level of the grains is between 63% and 52%.

4. The method according to claim 1, characterized in that the raw immature grains without any glumes are cooked.

5. The method according to claim 4, characterized in that the immature grains are cooked by a hydrothermal cooking method.

6. The method according to claim 5, characterized in that the immature grains are cooked in an atmosphere comprising steam at a temperature between 70 and 200° C. for one or several phases ranging from 10 to 120 minutes.

7. The method according to claim 6, characterized in that the immature grains are cooked until they have a moisture level larger than or equal to 50%.

8. The method according to claim 7, characterized in that the immature grains are cooked until they have a moisture level between 65 and 75%.

9. The method according to claim 1, characterized in that, before conditioning the grains, the latter are mixed with brine.

10. The method according to claim 1, characterized in that the raw immature grains without any glumes are dried.

11. The method according to claim 10, characterized in that the raw immature grains without any glumes are dried until they have a moisture level less than or equal to 15%

12. The method according to claim 10, characterized in that the dried grains are roasted and/or torrefied.

13. The method according to claim 1, characterized in that removal of the glumes and/or glumellae is achieved by introducing the grains into at least one fluid projected over at least one plate.

14. The method according to claim 13, characterized in that the grains are introduced into a high pressure water jet.

15. The method according to claim 14, characterized in that the water jet has a pressure between 50 and 200 bars.

16. The method according to claim 14, characterized in that the grains and glumes and/or glumellae which have been detached from said grains are recovered in a first settling bath in which water is stirred in order to separate the grains from the glumes and/or glumellae.

17. The method according to claim 16, characterized in that the grains are removed from the settling bath and then stirred for removing the water.

18. Immature grains of monocotyledonous plants, notably of poaceae, and in particular of graminae, the glumes and/or glumellae of which have been removed, capable of being obtained by at least the following steps:
harvesting plants in an immature condition, and then
separating the grains, and then
removing glumes and/or glumellae from the grains without drying or torrefaction, in order to obtain raw and entire immature grains, substantially without glumes and/or glumellae.

19. Immature grains of monocotyledonous plants, notably of poaceae, and in particular of graminae, characterized in that the total fiber content is between 12 and 20%.

20. The immature grains according to claim 19, characterized in that they have a green color with a green index (100-a) between 92 and 120 and a luminance (L) between 50 and 65.

21. The immature grains according to claim 19, characterized in that they have a phytic acid content between 2 and 3.2 mg/g.

22. The immature grains according to claim 19, characterized in that they have a ferulic acid content between 1,800 and 2,600 μg/g.

23. The immature grains according to claim 19, characterized in that the potassium/phosphorus ratio is larger than 1.

24. A food composition comprising grains in which the total fiber content is between 12 and 20%.

25. A method for treating a vegetable material to be treated comprising the removal of one or several husks surrounding said vegetable material, characterized in that it comprises the following steps:
introducing the vegetable material to be treated into at least one fluid, and then
projecting the mixture of fluid and vegetable material to be treated onto at least one plate, the impact causing removal of the husk(s) surrounding said vegetable material.

26. The method according to claim 25, characterized in that the vegetable material to be treated is introduced into at least one water jet.

27. The method according to claim 26, characterized in that the water jet has a pressure between 50 and 200 bars.

28. The method according to claim 25, characterized in that, after impact on the plate, the mixture of water, of vegetable material and husks is recovered in at least one settling bath for separating the husks from the vegetable material.

29. The method according to claim 28, characterized in that the vegetable material is then removed from the bath and then drained.

30. The method according to claim 29, characterized in that draining is obtained by stirring.

31. A device for removing one or more husks surrounding a vegetable material to be treated, characterized in that it includes at least means (5,6) for forming at least one fluid flow (4), means (3) for introducing the products in the fluid flow and at least one plate (7) onto which the fluid flow (4) transporting the products is projected.

32. The device according to claim 31, characterized in that the means (5,6) for forming a fluid flow consist in at least one nozzle (5) connected to a pressurized water supply source (6) in order to form a water jet (4).

33. The device according to claim 32, characterized in that the water is pressurized at a pressure between 50 and 200 bars.

34. The device according to claim 32, characterized in that the water jet (4) extends substantially horizontally.

35. The device according to claim 34, characterized in that the means (3) for introducing the products in the water jet (4) consist in a conveyor belt (3) transporting the products just above the water jet (4) so that the products fall under the effect of gravity into said water jet (4).

36. The device according to claim 31, characterized in that the plate (7) is tilted with respect to the axis of the fluid flow (4) forming an angle α between 40 and 50°.

37. The device according to claim 36, characterized in that the plate (7) is tilted with respect to the axis of the fluid flow (4) forming an angle α of 45°.

38. The device according to claim 32, characterized in that it includes at least one settling tank (8) positioned under the plate (7) and in which the treated vegetable material, the husks and the water are recovered.

39. The device according to claim 38, characterized in that the settling tank (8) includes stirring means (10).

40. The device according to claim 39, characterized in that the means for stirring (10) the settling tank (8) consist of water jets (10) mixed with air emerging in the bottom of the settling tank (8).

41. A food composition comprising grains obtained at least by the following steps:
harvesting plants in an immature condition, and then
separating the grains, and then
removing glumes and/or glumellae from the grains without drying or torrefaction, in order to obtain raw and entire immature grains, substantially without glumes and/or glumellae.
